(19) United States
(12) Patent Application Publication
(10) Pub. No.: US 2026/0192665 A1
(43) Pub. Date: Jul. 9, 2026

(54) FLEXIBLE DISPLAY SCREEN FRONT BUMPER ASSEMBLY FOR A VEHICLE

(71) Applicant: BOLD PICKUP PARTS INC., Vancouver (CA)

(72) Inventors: Fu GUO, Vancouver (CA); Yongzhi GUO, Vancouver (CA)

(73) Assignee: BOLD PICKUP PARTS INC., Vancouver, BC (CA)

(21) Appl. No.: 19/010,263

(22) Filed: Jan. 6, 2025

(51) Int. Cl. B60K 35/22; B60K 35/60

(52) U.S. Cl. CPC B60K 35/223; B60K 35/60; B60K 2360/188; B60K 2360/332; B60K 2360/349

(57) ABSTRACT

A front bumper of a vehicle is provided with a flexible display screen, such as a flexible LED display screen, supported by a screen positioning frame that matches the curvature of the front bumper, ensuring that the flexible display screen aligns perfectly with the curved surface of the front bumper. An electric color-changing protective panel may be provided to protect the display screen from road or environmental hazards, the protective panel having a color that, when powered-off, matches a color of the vehicle so as to conceal the display screen, and that becomes transparent when powered-on to reveal and allow viewing of the display screen.

### BACKGROUND OF THE INVENTION

### 1. Field of the Invention

The present invention relates to a front bumper assembly for a vehicle, and in particular to a front bumper assembly having a flexible display screen, such as a flexible LED display screen. Because the display screen is flexible, it can be installed on OEM or replacement front bumpers having a wide variety of shapes and configurations, including curved front bumpers that lack planar sections capable of accommodating a rigid display screen, and/or without limitation resulting from the size of the non-curved sections.

The flexible display screen of the invention is capable of displaying various designs and multimedia to provide a more varied and attractive appearance for the front of the vehicle, and optionally to display messages and/or warnings.

In an exemplary embodiment of the invention, a brightness sensor may be included in the flexible display screen front bumper assembly to adjust the brightness of the flexible display screen and ensure visibility under different lighting conditions.

In addition, the flexible display screen front bumper assembly of the exemplary embodiment may include a motion sensor to enable the flexible display screen to automatically illuminate upon detecting when a person approaches the vehicle.

Still further, the flexible display screen front bumper assembly of the exemplary embodiment of the invention may include an electric color-changing protective panel for protecting the display screen from road and environmental hazards and that, when not powered, matches the vehicle's color, creating a seamless and aesthetically pleasing appearance. When the protective panel is powered, it becomes transparent so that when the flexible display screen included in the display lights up, content on the display screen becomes visible for a highly impactful visual effect.

The flexible display screen front bumper assembly may optionally be controlled via the vehicle's on-board computer, or remotely via a smartphone or mobile device app, or a computer program.

### 2. Description of Related Art

Copending U.S. patent application Ser. No. 18/411,168, filed Jan. 12, 2024, and incorporated by reference herein, discloses a replacement front bumper modified to include a rigid, planar LED display panel. The display panel allows the appearance of the replacement front bumper to be varied, enabling vehicle owners to replace dull and static original equipment (OEM) front bumpers with a more interesting and/or aesthetically pleasing replacement version.

A disadvantage of the replacement front bumper described in the copending application, however, is that it is limited to front bumpers having a planar surface on which to mount or install the rigid planar display panel, restricting the size of the display panel to the area of the planar surface, and precluding or making it difficult to integrate the display panel in front bumper configurations having a high degree of curvature.

Moreover, the rigid display panels used in the replacement front bumper of the copending application, which are protected by a transparent screen to allow the display to be viewed, are in generally aesthetically unappealing and detract from the appearance of the vehicle when not illuminated.

Still further, the front bumper LED display disclosed in the copending application can be difficult to view depending on ambient light conditions such as direct sunlight, with no provision for adjusting the brightness of the display, or controlling the display to respond to the presence of persons in the area of the vehicle.

The present invention modifies the replacement front bumper display disclosed in the copending application by utilizing a flexible rather than rigid display panel and support, allowing the front bumper display to be utilized in a much wider variety of front bumper configurations. Because the flexible front bumper display is not limited to flat areas of the front bumper, the size of the panel can be increased to encompass curved sections of the front bumper.

Although illustrated as a replacement front bumper, the principles of the invention are not limited to replacement front bumpers but can also be utilized in OEM bumpers. To the contrary, by providing an electric color-changing protective screen that assumes the color of the bumper when the screen is not illuminated, the front bumper can be included in OEM front bumpers without detracting from the overall design and traditional appearance of the vehicle.

By way of background, the used of flat panel message displays on portions of vehicles other than front bumpers is well known. For example, there have been many proposals to include flat panel displays on the sides or rear of vehicles such as a box trucks or buses, and on advertising billboards or informational signs mounted to the roof of taxis or rideshare vehicles. Since the front, side, or roof of such vehicles tend to include or large planar areas, there is no need for use of flexible display panels. However, none of the previously-proposed vehicle message displays is integrated into a front bumper, so as to enable the appearance of the front bumper to be varied. Examples of such front, side, or roof displays are disclosed in U.S. Pat. Nos. 10,755,613, 9,963,028, 7,478,492, and 7,231,734, U.S. Patent Publication No. 2006/0290158, and Chinese Patent Publication No. 202029737. For example, U.S. Pat. No. 9,963,028 discloses a display screen that replaces a vehicle's rear license plate assembly and is supplied with data through a Wi-Fi connection to a controller in the vehicle.

### SUMMARY OF THE INVENTION

It is accordingly a first objective of the invention to provide a front bumper display screen assembly having enhanced functionality and improved appearance.

It is a second objective of the invention to provide a front bumper display screen assembly that can be utilized in a wide variety of vehicles with different front bumper configurations, including front bumpers with a high degree of curvature.

It is a third objective of the invention to provide a display screen assembly that can be integrated with a vehicle front bumper, and that can be placed anywhere on the bumper, including curved areas.

It is a fourth objective of the invention to provide a display screen assembly for the front bumper of a vehicle having enhanced visibility under different lighting conditions.

It is a fifth objective of the invention to provide a display screen assembly for the front bumper of a vehicle that is activated when a person is within proximity to the vehicle.

It is a sixth objective of the invention to provide a display screen assembly for the front bumper of a vehicle having an improved human machine interface.

It is a seventh objective of the invention to provide a display screen assembly for the front bumper of a vehicle in which the color of the display screen assembly blends in with that of the front bumper to conceal the screen when the screen is not illuminated, so as not to detract from the appearance of the vehicle.

These and other objectives of the invention are achieved by an exemplary embodiment in which the front bumper, which can be an OEM or replacement front bumper, is provided with a flexible display screen assembly rather than a rigid display panel, the flexible display screen of the assembly being supported by a screen positioning frame that matches the curvature of the front bumper, ensuring that the flexible display screen assembly aligns perfectly with the curved surface of the front bumper. As a result, the display screen assembly of the exemplary embodiment is not limited in size by a need to install the display screen assembly on flat areas of the bumper.

Although the front bumper display screen assembly of the exemplary embodiment of the invention is an LED display screen, it will be appreciated that the display screen assembly is not limited to LED display screen, and that other flexible display screen technologies may be utilized.

According to the exemplary embodiment of the invention described herein, the front bumper display screen assembly may be provided with a display brightness sensor to allow the display screen to automatically adjust to the optimal brightness for viewing based on detection of ambient light conditions.

The front bumper display screen assembly of the exemplary embodiment may further be provided with a human motion detection sensor so that, when people approach or are in proximity to the vehicle, the display will automatically activate, showcasing personalized patterns of the vehicle.

In an especially advantageous feature of the exemplary embodiment of the invention, the front bumper display screen assembly includes a shield or protective panel for protecting the display screen from road and environmental hazards such as flying debris, or from minor collisions. The protective panel is, in the exemplary embodiment, an electric color-changing protective panel that matches the color of the vehicle's front bumper when the LED display is not illuminated, and that becomes transparent when the LED screen is powered up so that the content of the display is visible through the protective screen.

In addition, the front bumper display screen assembly of the exemplary embodiment may include a screen controller and a screen receiving card that allow users to operate and modify the display content and effects of the flexible display screen using various devices such as the vehicle's onboard computer, smartphones, personal computers, and tablets, significantly enhancing personalization and content customization experiences. Data and control signals for the display screen may be provided through a data cable or Wi-Fi connection to the in-vehicle infotainment system

These and other advantages of the invention may be understood in connection with the following description of exemplary embodiments of the invention, with reference to the appended drawings.

### BRIEF DESCRIPTION OF THE DRAWINGS

FIG. 1 is a front view of a replacement front bumper display screen assembly with a flexible LED display screen constructed in accordance with the principles of an exemplary embodiment of the invention;

FIG. 2 is a top view of the front bumper display screen assembly of FIG. 1;

FIG. 3 is a left side view of the front bumper display screen assembly of FIG. 1;

FIG. 4 is a rear view of the front bumper display screen assembly of FIG. 1;

FIG. 5 is a front isometric view of the front bumper display screen assembly of FIG. 1;

FIG. 6 is an exploded rear isometric view of the front bumper display screen assembly of FIG. 1;

FIG. 7 is a schematic diagram showing installation of an LED screen positioning frame, motion detection sensor, screen controller and screen receiver card in the front bumper display screen assembly of FIG. 1.

FIG. 8 is a schematic diagram showing the manner in which the flexible LED screen is installed on the positioning frame of the exemplary embodiment.

FIG. 9 is an isometric view of an LED screen controller for use in the front bumper display screen assembly of FIGS. 1-8.

FIG. 10 is an isometric view of an LED screen receiver card for use in the front bumper display screen assembly of FIGS. 1-8.

FIG. 11 is an isometric view of a motion detector sensor for use in the bumper display screen assembly of FIGS. 1-8.

FIG. 12 is an isometric view of an LED screen brightness sensor for use in the bumper display screen assembly of FIGS. 1-8

### DETAILED DESCRIPTION OF THE PREFERRED EMBODIMENTS

The following description refers to a flexible LED display screen. Flexible LED display screens are well-known and commercially available. However, it is intended that the invention not be limited to LED display screens. It is anticipated that other types of flexible display screen technologies may be developed or become available that could be substituted for the flexible LED display screen of the exemplary embodiment.

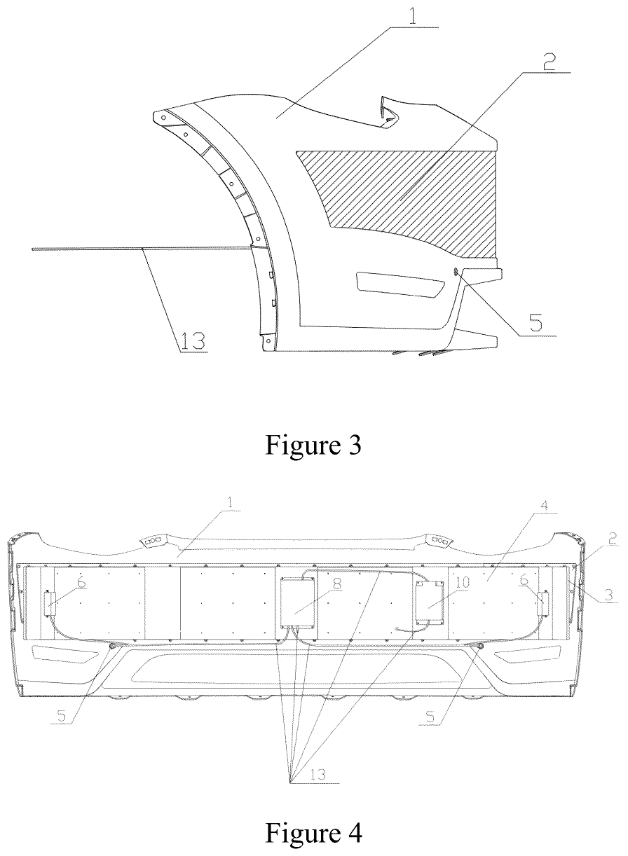

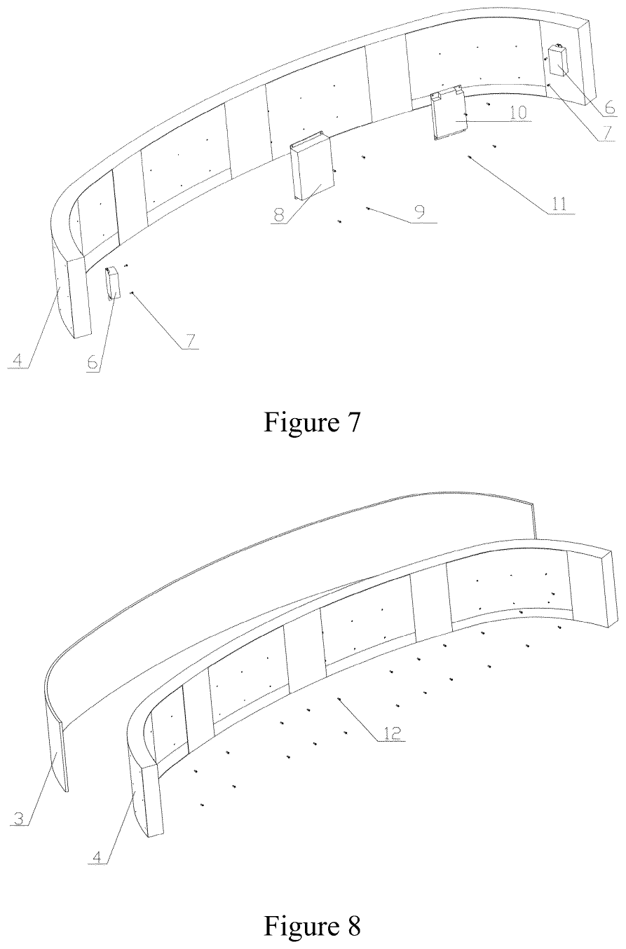

As shown in FIGS. 1-8, a front bumper with a flexible LED screen assembly constructed in accordance with the principles of an exemplary embodiment of the invention includes an electric color-changing protective panel 2 embedded in or installed on a front bumper 1 and positioned in front of a flexible LED screen 3. The front bumper 1 may either be an original equipment (OEM) or after-market replacement bumper and may include features that enable it to be secured or mounted to the front of the vehicle's body or frame. Features relating to the construction of the bumper or attachment to the vehicle are well-known to those skilled in the art and are therefore omitted from the following description unless they relate to the inclusion of the flexible LED display screen assembly.

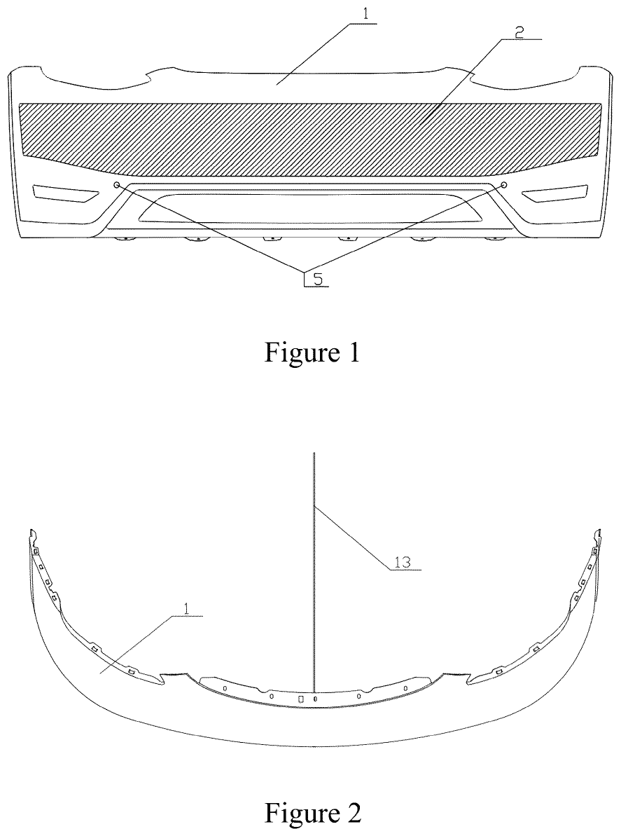

The front bumper 1 illustrated in FIGS. 1-8 may have any shape compatible with the shape of the vehicle. As shown in FIG. 2, for example, the front surface of the bumper 1 has a continuous curvature. As best shown in FIG. 6, the flexible LED screen 3 is supported by a screen positioning frame 4 that matches the curvature of the front bumper 1, with the flexible LED screen 3 having been cut and bent to conform to the curvature of an upper front surface of the bumper 1. The electric color-changing protective panel 2 is similarly curved to conform to the curvatures of the LED screen 3 screen positioning frame 4 and the front bumper 1. Because the LED screen 3 is flexible and can therefore curve to conform to the shape of the front bumper 1, there is no need to modify the shape of the bumper 1 to accommodate the LED screen, and no need to limit the size of the LED screen to flattened or planar areas of the bumper.

The flexible LED screen 3 is secured to the LED screen positioning frame 4 using LED screen positioning bolts 12, ensuring that the two surfaces align and adhere to each other's curvatures. This arrangement ensures that the curvature of the flexible LED screen also perfectly matches the curvature of the front bumper 1.

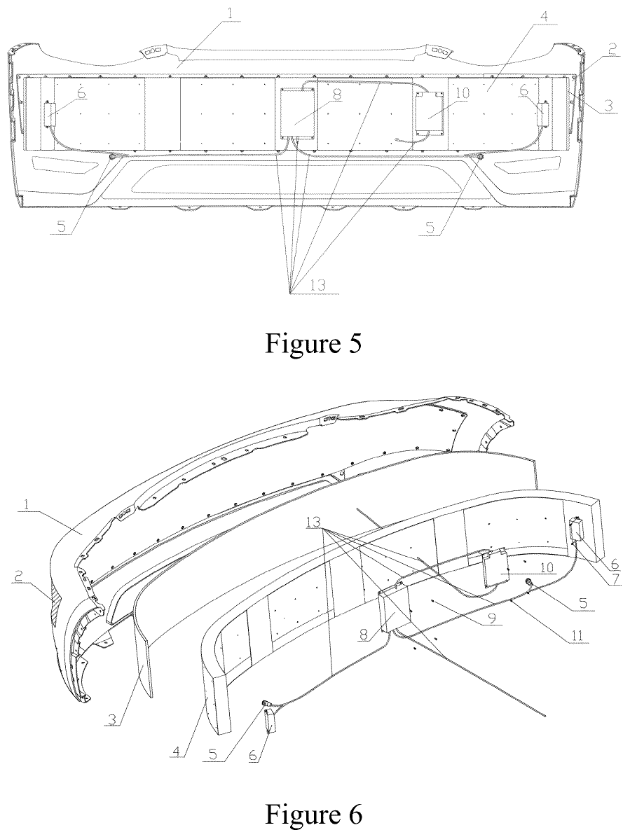

As shown in FIGS. 5 and 6, two LED screen brightness sensors 5 are connected to the front bumper 1 and are symmetrically positioned on the left and right sides of the bumper. In addition, two motion detection sensors 6 are connected to the LED screen positioning frame 4 through motion detection sensor positioning bolts 7 and are symmetrically positioned on the left and right sides of the positioning frame 4. The LED screen controller 8 is connected to the LED screen positioning frame 4 through the LED screen controller positioning bolts 9. The LED screen receiving card 10 is connected to the LED screen positioning frame 4 through LED screen receiving card positioning bolts 11. Of course, the numbers and positions of the sensors 5 may be varied without departing from the scope of the invention.

The LED screen brightness sensor 5, motion detection sensors 6, LED screen controller 8, and LED screen receiving card 10 are connected to the flexible LED screen 3 via a power data cable 13, shown in FIG. 6. This setup enables image transmission and the ability to change displayed content, as well as automatic brightness adjustment to compensate for changes in ambient light and ensure visibility, and automatic screen illumination upon detecting a human presence so as to save energy by only illuminating the screen when someone is in a position to view the screen.

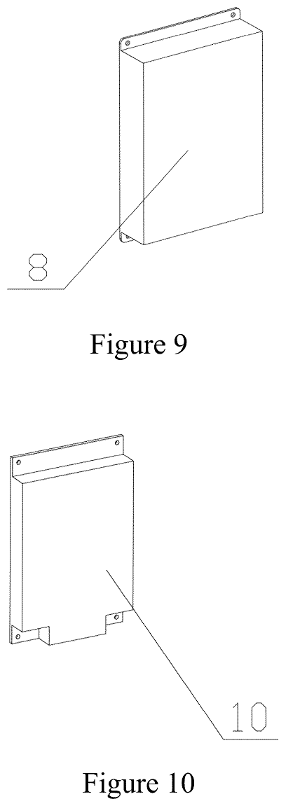

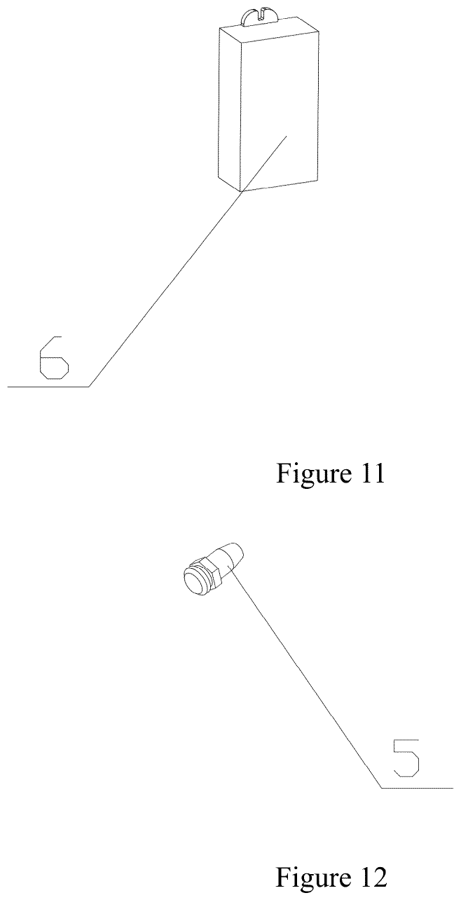

FIGS. 9-12 respectively show, by way of example and not limitation, an LED screen controller 8, LED screen receiver card 10, motion detection sensor 6, and LED screen brightness sensor 5 that may be utilized in the exemplary embodiment of FIGS. 1-8. It will be appreciated by those skilled in the art that the invention should not be limited to the illustrated screen controller, screen receiver card, motion detection sensor, or screen brightness sensor, and further that any or all of the components shown in FIGS. 9-10 may be modified or omitted without departing from the scope of the invention.

Optionally, power to the flexible LED display screen 3 may be supplied by the vehicle's infotainment system, by a separate battery, or by a solar power supply, for example as described in copending U.S. patent application Ser. No. 18/411,168, or by any other suitable power supply.

Although preferred embodiments of the invention have been described in connection with the appended drawings, it will be appreciated by those skilled in the art that the description of the preferred embodiments is not intended to be limiting. For example, the front bumper assembly of the exemplary embodiments may include additional parts and features not illustrated herein. As a result, it is intended that modifications of the preferred embodiments may be made without departing from the scope of the invention, which should be limited solely by the appended claims

What is claimed is:

1. A flexible front bumper display screen assembly for a vehicle, comprising:
a positioning frame configured to be secured to, embedded in, or integrated with a front bumper of the vehicle; and
a flexible display screen,
wherein the positioning frame includes sections having a curvature that conforms to a curvature of the front bumper, and
wherein the flexible display screen is supported by and conforms to the curvature of the positioning frame and the front bumper.

2. The flexible front bumper display screen assembly as claimed in claim 1, wherein the flexible display screen is a flexible LED display screen.

3. The flexible front bumper display screen assembly as claimed in claim 1, further comprising at least one brightness sensor for automatically adjusting a brightness of the flexible display screen in response to changes in ambient light.

4. The flexible front bumper display screen assembly as claimed in claim 1, further comprising a protective panel positioned in front of the flexible display screen for protecting the flexible display screen from road and environmental hazards.

5. The flexible front bumper display screen assembly as claimed in claim 4, wherein the protective panel is an electric color-changing protective panel that matches a color of the vehicle when in a powered-off mode, and that becomes transparent in a powered-on mode to enable content on the flexible display screen to become visible through the protective panel.

6. The flexible front bumper display screen assembly as claimed in claim 1, further comprising a screen controller and screen receiver card for enabling operation of the flexible display screen through an infotainment or control system of the vehicle, a remote computer, or a mobile device.

7. The flexible front bumper display screen assembly as claimed in claim 1, wherein the flexible display screen is positioned behind the front bumper, and is configured to display personalized patterns or designs, messages, or videos.
